(19) United States
(12) Patent Application Publication
(10) Pub. No.: US 2013/0236651 A1
(43) Pub. Date: Sep. 12, 2013

(54) SHIM MEMBER, DIE COATER, AND METHOD FOR PRODUCING COATING FILM

(71) Applicant: NITTO DENKO CORPORATION, Osaka (JP)

(72) Inventors: Makoto Komatsubara, Ibaraki-shi (JP); Hajime Michihira, Ibaraki-shi (JP)

(73) Assignee: NITTO DENKO CORPORATION, Osaka (JP)

(21) Appl. No.: 13/775,683

(22) Filed: Feb. 25, 2013

(30) Foreign Application Priority Data
Mar. 7, 2012 (JP) 2012-050944
Dec. 5, 2012 (JP) 2012-266744

(51) Int. Cl. B05C 21/00; B05D 1/26

(52) U.S. Cl. CPC B05C 21/00; B05D 1/265
USPC 427/430.1; 118/300

(57) ABSTRACT

Provided is a shim member which is sandwiched between two die blocks provided in a the coater, and has the U shape formed by a base end portion which is arranged so as to extend in a longitudinal direction of the slot, and a pair of extending portions which extend toward a nose portion of the die from both ends in a longitudinal direction of the base end portion, wherein a first portion which is a nose portion of at least one extending portion or the whole of at least the one extending portion, out of the pair of the extending portions, and a second portion which is the remaining portion including at least the base end portion, are structured so as to be separable from each other.

### CROSS REFERENCE TO RELATED APPLICATION

The present application claims priority of Japanese Patent Application Nos. 2012-050944 and 2012-266744, which are incorporated in the specification of the present application by reference.

### BACKGROUND OF THE INVENTION

1. Field of the Invention

The present invention relates to a shim member, a die coater, and a method for producing a coating film.

2. Description of the Related Art

Conventionally, a die coater which has a slot that discharges a coating liquid therefrom provided in a die is known as one of coating applicators. The die coater extrudes the supplied coating liquid from the slot, and also applies the coating liquid onto a substrate such as a film, by bringing the substrate close to the slot and moving the substrate relatively with respect to the slot.

There is the case in which this type of die coater applies the coating liquid to the substrate so as to form variously different coating widths according to the application and the like. In this case, a plurality of die coaters having different coating widths are used, which is extremely wasteful.

Then, a die coater is proposed which is provided with two die blocks and a plurality of shim members, and is structured so as to form a cavity and a slot by sandwiching and fixing the shim member between the two die blocks (c.f., Patent Document 1). Such die coater can change a coating width by replacing a shim member which is sandwiched between die blocks with a shim member having a coating width different from that of the previous shim member.

### PRIOR ART DOCUMENTS

### Patent Documents

Patent Document 1: Japanese Patent Application Laid-Open No. 2009-18227

### SUMMARY OF THE INVENTION

However, in such a die coater, it is necessary that every time the coating width is changed, the die coater is disassembled, a shim member is removed from the die coater, and a shim member having a coating width different from that of the previous shim member is mounted on the die coater again. For this reason, an operation for changing the coating width may become complicated.

With respect to the above described problems, an object of the present invention is to facilitate the coating width of the die coater to be changed.

According to the present invention, there is provided a shim member which is sandwiched between two die blocks that a die has and are arranged so as to face each other and is formed in such a U shape as to be opened toward a slot side so that the slot which is a discharge port of a coating liquid is formed at a nose portion of the die provided in a die coater, wherein the U shape is formed by a base end portion which is arranged so as to extend in a longitudinal direction of the slot, and a pair of extending portions which extend toward the nose portion of the die from both ends in a longitudinal direction of the base end portion; and a first portion which is a nose portion of at least one extending portion or the whole of at least the one extending portion, out of the pair of the extending portions, and a second portion which is a remaining portion including at least the base end portion, are structured so as to be separable from each other.

In such a structure, the first portion which is the nose portion of at least one extending portion or the whole of at least the one extending portion, out of the pair of the extending portions, and the second portion which is the remaining portion including at least the base end portion, are structured so as to be separable from each other. Thereby, the first portion can be structured, for instance, so as to be movable in the longitudinal direction relatively with respect to the second portion. In this case, the shim member can change the coating width in a state of being sandwiched between the two die blocks, by relatively moving the first portion.

In addition, the shim member can be structured so as to form the first portion by providing a plurality of members for the first portion, which have different lengths from each other in the above described longitudinal direction when being used as the first portion, respectively, and by selecting and employing one member from the plurality of the members for the first portion. In this case, the coating width can be changed by replacing the member for the first portion.

Accordingly, the coating width can be changed to a desired width without disassembling the die coater. Accordingly, the coating width can be easily changed.

In addition, in the shim member, the first portion is preferably structured so as to be movable in the longitudinal direction of the slot relatively with respect to the second portion.

The shim member having such a structure can change the coating width to a desired width only by moving the above described first portion in a longitudinal direction of the slot relatively with respect to the above described second portion, in a state of being sandwiched between the two die blocks, without being removed from the die blocks. Accordingly, the coating width can be more easily changed.

In addition, in the shim member, it is preferable that the first portion is a nose portion of at least one of the pair of the extending portions, and the nose portion extends along the longitudinal direction so as to project at least toward the inside.

The shim member having such a structure can be structured, for instance, so that the nose portion can relatively move. In this case, the shim member can change the coating width only by relatively moving the nose portion.

In addition, the shim member can also be structured so as to form the nose portion by providing a plurality of members for the nose portion, selecting one member from these members and employing the member. In this case, the shim member can change the coating width only by replacing a member for the nose portion with the other member. Accordingly, the coating width is more easily changed.

The nose portion is preferably structured so as to form such a shape that the distance from each other expands toward an opening side of the slot.

The shim member having such a structure can more surely uniformize the thickness of a coating film applied, for instance, onto a substrate or the like along a width direction.

In addition, in the shim member, it is preferable that the first portion is the whole of at least one of the pair of the extending portions.

The shim member having such a structure can more simplify the shapes of the first portion and the second portion.

In addition, in the shim member, it is preferable that the plurality of the members for the first portion are provided, respectively, the plurality of the members have lengths different from each other in the longitudinal direction when used as the first portion, the first portion has a structure including one member which is selected from the plurality of the members and employed, and members to be used are structured so as to be replaceable with each other.

The shim member having such a structure can change the coating width only by replacing the above described member with another member and forming the first portion, and accordingly can more easily change the coating width.

In addition, the die coater according to the present invention includes the shim member.

According to another aspect of the present invention, there is provided a method for producing a coating film, which produces the coating film on a substrate, including: using a die coater including the shim member: changing a coating width in a longitudinal direction of the slot by moving the first portion in the longitudinal direction of the slot relatively with respect to the second portion; and producing the coating film on the substrate by making the slot discharge the coating liquid therefrom.

According to still another aspect of the present invention, there is provided a method for producing a coating film, which produces the coating film on a substrate, including: using a die coater including the shim member: changing a coating width in the longitudinal direction of the slot by replacing a member which is selected from the plurality of the members and employed, with another member; and producing the coating film on the substrate by making the slot discharge the coating liquid therefrom.

In addition, the method for producing the coating film preferably includes further changing the coating width in the longitudinal direction of the slot further by moving the replaced member relatively in the longitudinal direction.

As described above, according to the present invention, the coating width in the die coater can be easily changed.

### BRIEF DESCRIPTION OF THE DRAWINGS

FIG. 1 is a schematic block diagram illustrating a die coater provided with a shim member according to a first embodiment of the present invention;

FIG. 2 is a schematic perspective view of a die;

FIG. 3A is a schematic side view of the die in FIG. 2;

FIG. 3B is a schematic top plan view of the die in FIG. 2;

FIG. 4A is a schematic exploded side view of the die in FIG. 3;

FIG. 4B is a schematic top plan view of a first die block in FIG. 4A;

FIG. 4C is a schematic top plan view of a shim member in FIG. 4A;

FIG. 4D is a schematic top plan view of a second die block in FIG. 4A;

FIG. 5A is a schematic top plan view illustrating a state in which the coating width has been determined to be comparatively small by the shim member;

FIG. 5B is a schematic top plan view illustrating a state in which the coating width is comparatively increased by the shim member;

FIG. 6A is a schematic top plan view illustrating one embodiment of a first portion;

FIG. 6B is a schematic top plan view illustrating one embodiment of the first portion;

FIG. 6C is a schematic top plan view illustrating one embodiment of the first portion;

FIG. 6D is a schematic top plan view illustrating one embodiment of the first portion;

FIG. 6E is a schematic top plan view illustrating one embodiment of the first portion;

FIG. 7 is a schematic side view illustrating one embodiment of the die;

FIG. 8A is a schematic top plan view illustrating one embodiment of a first die block;

FIG. 8B is a schematic top plan view illustrating one embodiment of the first die block;

FIG. 9A is a schematic top plan view illustrating one embodiment of the first portion;

FIG. 9B is a schematic top plan view illustrating one embodiment of the first portion;

FIG. 10A is a schematic top plan view illustrating a member for a first portion with a comparatively small length in a longitudinal direction;

FIG. 10B is a schematic top plan view illustrating a member for a first portion with a comparatively large length in the longitudinal direction;

FIG. 11A is a schematic top plan view illustrating a state in which the member for a first portion with a comparatively small length in the longitudinal direction has been selected and has been employed, in a shim member of the present embodiment;

FIG. 11B is a schematic top plan view illustrating a state in which a member for a first portion with a comparatively large length in the longitudinal direction has been selected and has been employed;

FIG. 12A is a schematic exploded side view of a die in a die coater provided with a shim member of the present embodiment;

FIG. 12B is a schematic top plan view of a first die block in FIG. 12A;

FIG. 12C is a schematic top plan view of the shim member in FIG. 12A;

FIG. 12D is a schematic top plan view of a second die block in FIG. 12A;

FIG. 13A is a schematic side view illustrating a state in which a first portion is fixed;

FIG. 13B is a schematic side view illustrating a state in which the fixation of the first portion has been released;

FIG. 14A is a schematic exploded side view of a die in a die coater provided with a shim member of the present embodiment;

FIG. 14B is a schematic top plan view of a first die block in FIG. 14A;

FIG. 14C is a schematic top plan view of the shim member in FIG. 14A;

FIG. 14D is a schematic top plan view of a second die block in FIG. 14A;

FIG. 15A is a schematic top plan view illustrating a state in which a member for a first portion with a comparatively small length in the longitudinal direction has been selected and has been employed, in the shim member of the present embodiment;

FIG. 15B is a schematic top plan view illustrating a state in which a member for the first portion with a comparatively large length in the longitudinal direction has been selected and has been employed;

FIG. 16A is a schematic side view illustrating a state in which a first portion is fixed;

FIG. 16B is a schematic side view illustrating a state in which the fixation of the first portion has been released;

FIG. 17A is a schematic top plan view illustrating a shim member of a second embodiment of the present invention, and is a view illustrating a state in which the coating width has been set to be comparatively small;

FIG. 17B is a schematic top plan view illustrating the shim member of the second embodiment of the present invention, and is a view illustrating a state in which the coating width has been set to be comparatively large;

FIG. 18 is a schematic top plan view illustrating a shim member of a third embodiment of the present invention;

FIG. 19 is a schematic top plan view illustrating a shim member of one embodiment which is used in a reference example; and

FIG. 20 is a graph illustrating a relationship between a position and a thickness in a width direction of a coating film.

### DETAILED DESCRIPTION OF THE PREFERRED EMBODIMENTS

A die coater provided with a shim member according to an embodiment of the present invention will be described below with reference to the drawings.

Firstly, a die coater provided with a shim member according to a first embodiment of the present invention will be described below.

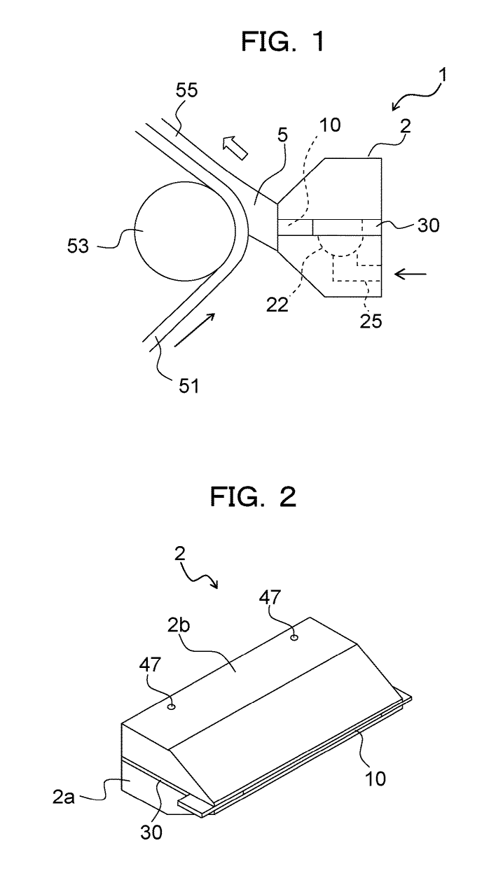

As are illustrated in FIG. 1 to FIG. 4, the die coater 1 of the present embodiment includes: a die 2 having a first die block 2a and a second die block 2b (two die blocks); and a shim member 30 which is sandwiched between the two die blocks and is formed into such a U shape as to be opened toward a slot 10 side. Such a the coater 1 discharges a coating liquid 5 onto a substrate 51 which is supported by a roller member 53 and moves, for instance, and thereby forms a coating film 55 on the substrate 51.

The die 2 includes the first die block 2a and the second die block 2b which are arranged so as to face each other so that the slot 10 is formed on a nose portion of the die. The first die block 2a has a recessed portion formed therein along a longitudinal direction, and the recessed portion is structured so as to form a cavity 22 to which the coating liquid 5 is supplied, by being covered with the second die block 2b. The cavity 22 and the slot 10 communicate with each other, and the cavity 22 is structured so as to supply the coating liquid 5 to the slot 10 therefrom. In addition, the first die block 2a and the second die block 2b have threaded screw holes 41 and 43 through which a bolt 47 is threaded formed therein, respectively.

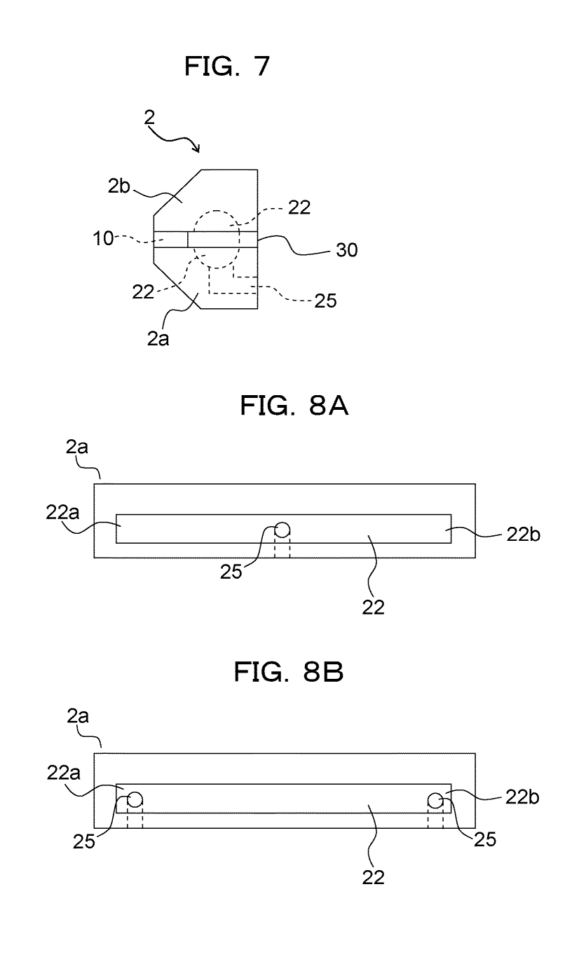

Incidentally, as is illustrated in FIG. 7, the cavity 22 may be formed also by the recessed portions which have been formed in each of the first die block 2a and the second die block 2b and have been abutted against each other when the first die block 2a and the second die block 2b have been arranged so as to face each other.

A liquid supply port 25 which is formed in the first die block 2a communicates with the cavity 22 so that the coating liquid 5 is supplied to the cavity 22, in one end portion 22a in the longitudinal direction of the cavity 22, and the coating liquid 5 is supplied to the cavity 22 through the liquid supply port 25. In addition, the coating liquid 5 which has been supplied to the cavity 22 is supplied to the slot 10 while moving toward the other end portion 22b from the above described first end portion 22a.

Incidentally, the liquid supply port 25 may be provided in the central portion in the longitudinal direction of the cavity 22, as is illustrated in FIG. 8A, or the liquid supply ports 25 may be provided one each in both ends in the longitudinal direction of the cavity 22, as is illustrated in FIG. 8B.

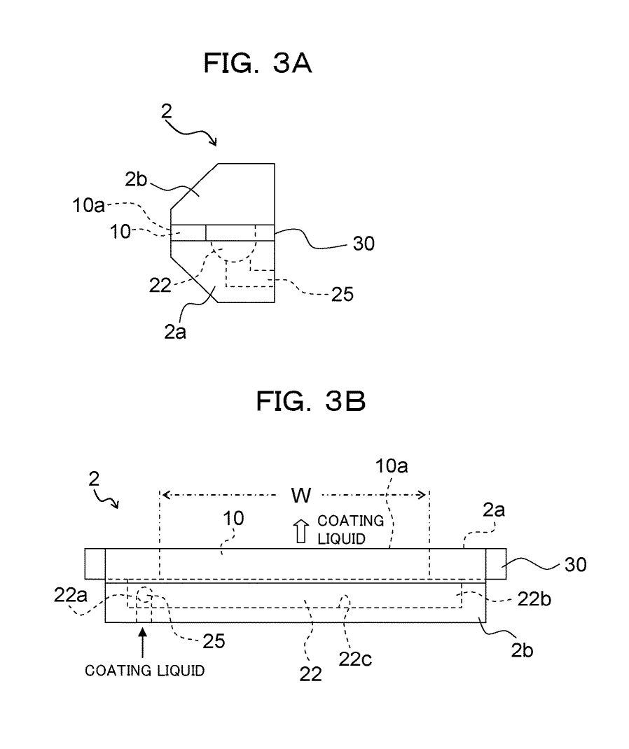

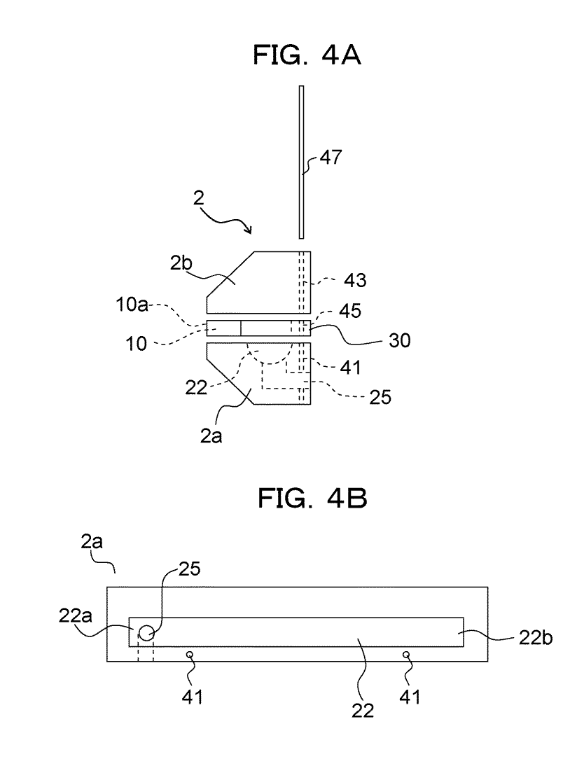

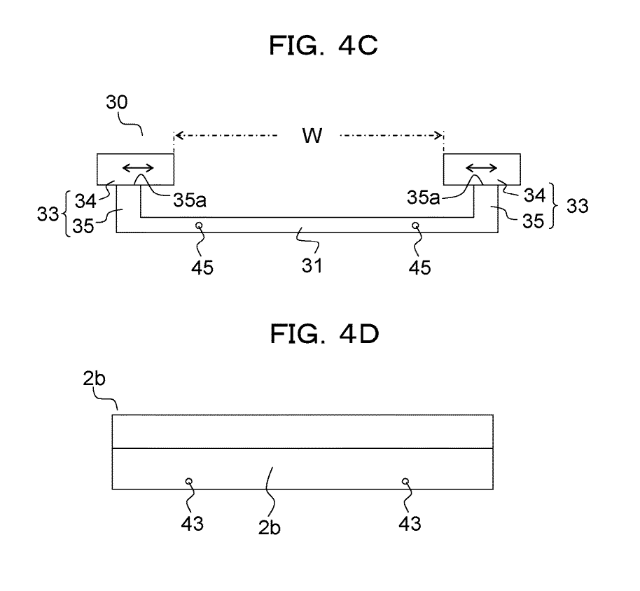

As are illustrated in FIG. 3 and FIG. 4, the shim member 30 is sandwiched between the first die block 2a and the second die block 2b (hereinafter occasionally referred to as two die blocks), and thereby is structured to form the slot 10 which discharges the coating liquid 5 from an opening 10a.

Such a shim member 30 is formed into a U shape by a base end portion 31 which is arranged so as to extend in the longitudinal direction of the slot 10, and a pair of extending portions 33 which extend toward an opening 10a side (in other words, toward the nose portion of the die 2) from both ends in the longitudinal direction of the base end portion 31.

The base end portion 31 is arranged along end edges in the above described longitudinal direction (a horizontal direction in FIG. 3B) of the recessed portion in the above described first the block 2a, and the two extending portions 33 are arranged along the end edges in a transverse direction (a vertical direction in FIG. 3B) of the recessed portion. The base end portion 31 and the two extending portions 33 are structured so as to form a part of a wall face of the cavity 22 by being sandwiched between the first die block 2a and the second die block 2b.

In addition, the shim member 30 is structured so that a first portion (in the present embodiment, a nose portion 34 which will be described later) which is the nose portion 34 of at least one extending portion 33 or the whole of at least the one extending portion 33, out of the pair of the extending portions 33, and a second portion (in the present embodiment, the base end portion 31 and a remaining portion 35 which will be described later) which is the remaining portion including at least the base end portion 31, can be separated from each other. More specifically, the shim member 30 is structured so that the above described first portion and the above described second portion can be separated from each other along the longitudinal direction of the base end portion 31. In addition, the above described first portion and the above described second portion are structured so that faces of the portions, on which the portions abut, extend along the longitudinal direction of the base end portion 31, when the portions are arranged so as to form a U shape as the shim member 30.

In the present embodiment, the nose portions 34 of both of the extending portions 33 are determined to be the first portion. More specifically, the pair of the extending portions 33 are formed so as to have the nose portion 34 which extends in parallel to the base end portion 31 along the above described longitudinal direction and so as to project at least toward the inside, and the nose portions 34 of both of the pair of the extending portions 33 are determined to be the first portion.

In addition, further specifically, at least one extending portion of the pair of the extending portions 33 has the nose portion 34 which extends so as to project inside and outside along the above described longitudinal direction and is formed so as to be a T-shape, and the nose portion 34 is determined to be the first portion (see FIG. 3B). Thus, a part of the nose portion 34 projects to the outer side than a space between the die blocks, and thereby this projecting portion can be grasped by fingers.

For information, at least one extending portion of the pair of the extending portions 33 may have the nose portion 34 which extends so as to project inside, and may also be formed so as to be an L-shape.

In addition, the remaining portion 35 in the base end portion 31 side in the extending portion 33 forms an indivisible integrated portion with the base end portion 31, and the integrated portion is determined to be the second portion. For information, a method for forming the above described first portion and the above described second portion includes a method of forming the portions by cutting a sheet of the shim member 30 with the use of a known cutting method such as a cutter. In addition, the method also includes a method for forming the portions by stamping each of the above described first portion and the above described second portion from one sheet of a plate-shaped material.

The two nose portions 34 (the first portion) are arranged so as to be separated from each other by a predetermined distance, and are structured so as to form the slot 10 by being sandwiched between the first die block 2a and the second die block 2b. The distance between such two nose portions 34 determines a coating width W.

In the present embodiment, the first portion can be structured, for instance, so as to be movable in the longitudinal direction of the slot 10 relatively with respect to the second portion. An example of such a structure will be described below. Specifically, these nose portions 34 are brought into contact with the nose portions 35a in the opening side of the remaining portions 35 of the extending portions 33, respectively, and can be moved in the longitudinal direction of the slot 10 relatively with respect to the nose portions 35a in the opening side (in other words, can be moved in the longitudinal direction of the slot 10 relatively with respect to the second portion). Thereby, the coating width W can be changed by an operation of moving at least one nose portion 34 of the two nose portions 34 relatively with respect to the above described integrated portion.

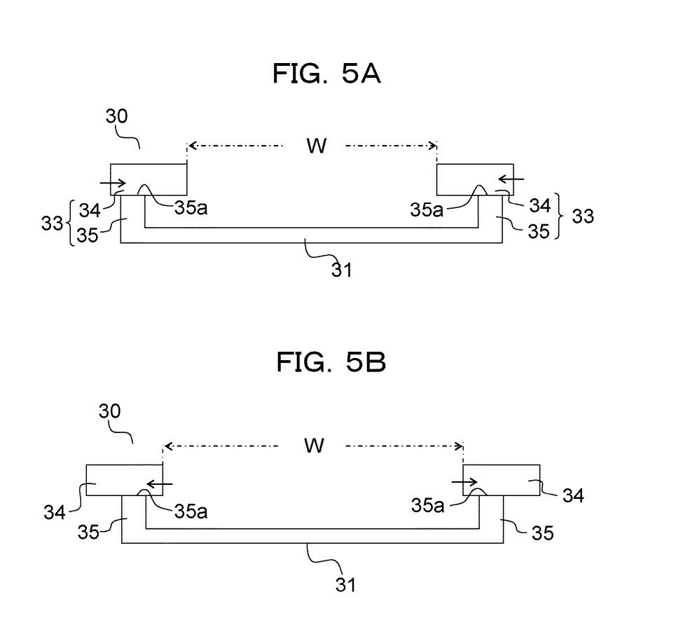

For instance, as is illustrated in FIG. 5A, when the two nose portions 34 are moved toward the inside of the pair of the extending portions 33 so as to become close to each other, the coating width W can be set to be comparatively small. On the other hand, as is illustrated in FIG. 5B, when the nose portions 34 are moved toward the outside of the pair of the extending portions 33 so as to become distant from each other, the coating width W can be set to be comparatively large. Incidentally, only one nose portion 34 of these two nose portions 34 may be moved.

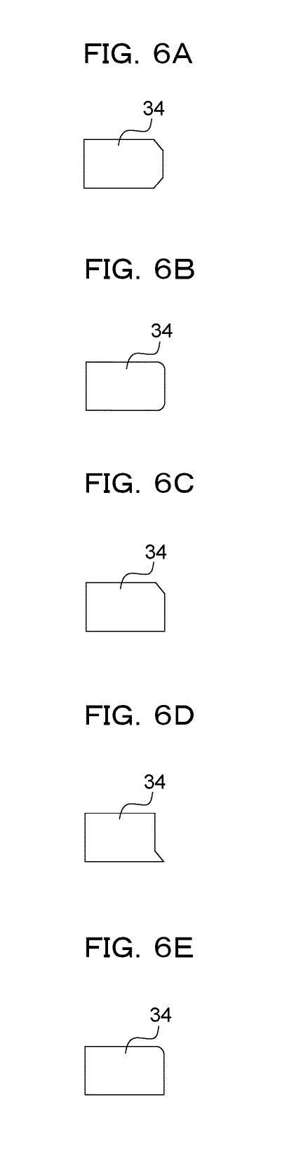

Incidentally, it is preferable that the nose portion 34 is formed into such a shape as to be an approximately rectangular shape and have corners chamfered, as is illustrated in FIG. 6A, is formed into such a shape as to be an approximately rectangular shape and have corners curved into an R shape, as is illustrated in FIG. 6B, or is formed, as other shapes, into such shapes as are illustrated in FIG. 6C to FIG. 6E. Specifically, it is preferable that the nose portion 34 is structured so as to have such a shape that the coating width expands toward the opening 10a (see FIG. 3 and FIG. 4) side, in other words, that the nose portion 34 is structured so as to have such a shape that the distance from each other expands toward the opening 10a (see FIG. 3 and FIG. 4) side, as is illustrated in FIG. 6A to FIG. 6E. By the nose portion 34 formed in this way, the thickness of the coating film 55 can be more surely uniformized throughout the longitudinal direction of the slot 10.

Specifically, when the coating liquid 5 has been applied onto the substrate 51, the coating liquid 5 generally tends to curl itself in both ends in the width direction, due to its surface tension. Because of this, the coating liquid shows a state in which both of the ends have humps or rounded protrusions higher than the central side.

In regard to this point, the nose portion 34 is structured so as to have such a shape that the distance from each other expands toward the opening 10a side, and thereby the coating liquid 5 which has flowed into the slot 10 from the cavity 22 spreads toward the outside in the width direction in the opening 10a side of the slot 10. The humps or rounded protrusions in both of the ends are thereby decreased by the amount of the spreading of the coating liquid 5. Thereby, the thicknesses in both of the ends in the width direction of the coating liquid 5 which has been applied onto the substrate 51 can be approached to that in the central side. Accordingly, the thickness of the coating film 55 can be more surely uniformized throughout the width direction (see FIG. 20).

In addition, as is illustrated in FIG. 4, the base end portion 31 has a through-hole 45 formed therein which a bolt 47 penetrates when the first die block 2a and the second die block 2b are connected to each other. Then, the shim member 30 is structured so as to be fixed in a state of being sandwiched between the first die block 2a and the second die block 2b, when the shim member 30 has been sandwiched between the first die block 2a and the second die block 2b and the blocks have been connected to each other by the bolt 47. In addition, the shim member 30 which has been fixed in this way is structured so as to prevent the coating liquid 5 from leaking from a space between the above described remaining portion 35 and the nose portion 34 or from a space between the shim member 30, and the first die block 2a and the second the block 2b.

The materials for the above described shim member 30 include a plastic film of polyethylene terephthalate (PET) or the like, and a metal foil of stainless steel (SUS), brass or the like. In addition, the shim member 30 is preferably formed by being cut out from one sheet of a plate. Thus, the shim member is formed by being cut out from one sheet of the plate in this way, and thereby the first portion and the second portion which constitute the shim member 30 have the same material and the same thickness. Thereby, the shim member can prevent further the leakage of the coating liquid 5.

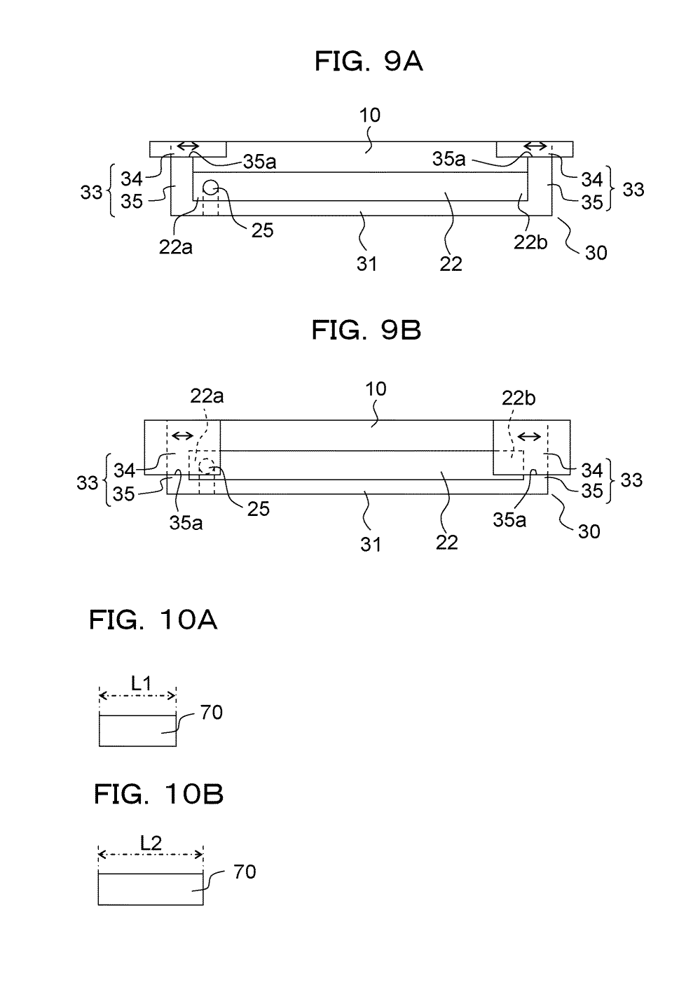

The length in the above described longitudinal direction of the nose portion 34 can be appropriately set. In addition, in the present embodiment, the length in the transverse direction of the nose portion 34 is set at the length in the transverse direction of the slot 10. Incidentally, the length in the transverse direction of the nose portion 34 may be set, for instance, so as to be smaller than the length in the transverse direction of the slot 10, as is illustrated in FIG. 9A, or may also be set so as to be larger than this length, as is illustrated in FIG. 9B.

In addition, the length in the transverse direction of the remaining portion 35 in the extending portion 33 may be set so as to be larger than the length in the transverse direction of the cavity 22 according to the length in the transverse direction of the nose portion 34 as described above, as is illustrated in FIG. 9A, or may also be set so as to be smaller than the length in the transverse direction of the cavity 22, as is illustrated in FIG. 9B.

Incidentally, when the shim member 30 is mounted on the die 2, end edges (here, end edges of the two nose portions 34) in the opening 10a side in the first portion can be structured, for instance, so as to become flush with both end edges (both nose edges) of the first die block 2a and the second die block 2b in the opening 10a side. In addition, the end edges also can be structured, for instance, so as to be arranged so as to project to the outer sides than both of these end edges. Alternatively, the end edges also can be structured, for instance, so as to be arranged so as to be recessed toward the inner sides than both of these end edges.

In addition, the shim member 30 is structured so as to be fixed so that the two nose portions 34 are not moved, when the shim member 30 described in the above is sandwiched between the first die block 2a and the second die block 2b and the blocks are connected to each other by the bolt 47 in the state, and so as to keep the coating width W constant. The shim member is also structured so that the coating liquid 5 is discharged from the slot 10 in this state.

When the coating width W is changed, the bolt 47 is loosened and the fixation of the two nose portions 34 is released. Subsequently, at least any one out of these nose portions 34 is moved and the coating width W is changed to a desired width. Then, the bolt 47 is tightened again. Thereby, the coating width W can be changed. Thus, the coating width W can be changed without removing the shim member 30.

In addition, in the present embodiment, in place of such a structure that the first portion is moved relatively with respect to the second portion as has been described above, the shim member may be structured, for instance, so that a plurality of the above described members for the first portion are prepared, respectively, the plurality of the members have different lengths in the longitudinal direction from each other when being used as the above described first portion, the above described first portion has a structure including one member which is selected from the plurality of the members and employed, and members to be used are replaceable with each other.

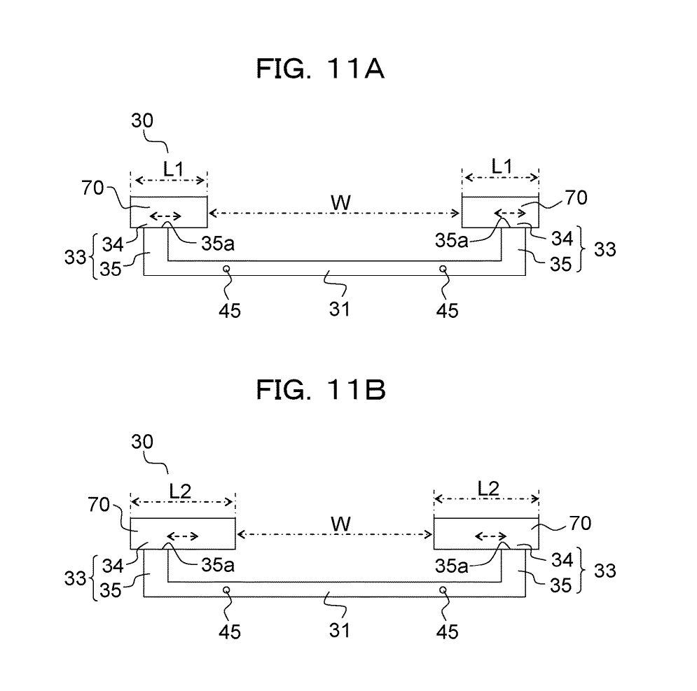

One example of such a structure will be described below. Specifically, a plurality of the members for the first portion (here, a member 70 for a nose portion, for the nose portion 34) are prepared for the shim members 30, respectively (see FIG. 10). The plurality of the members 70 for the nose portion have different lengths from each other in the longitudinal direction of the slot 10 when being used as the first member (here, the nose portion 34). In addition, the above described first portion (here, the nose portion 34) has a structure including one member 70 for the nose portion, which is selected from the plurality of the members 70 for the nose portion and employed (see FIG. 11A or FIG. 11B). The members 70 for the nose portion to be used are also structured so as to be replaceable with each other.

Each of the plurality of the members 70 for the nose portion is formed of a member 70 for the nose portion having a comparatively small length of L1 in the above described longitudinal direction, as is illustrated in FIG. 11A, and of a member 70 for the nose portion having a comparatively large length of L2 in the above described longitudinal direction, as is illustrated in FIG. 11B.

In addition, the base end portion 31 and the member 70 for the nose portion are structured so as to be fixed with the use of the bolt 47 (see FIG. 4), in a similar way to that in the above description.

In addition, the nose portion 34 has such a structure, for instance, that the member 70 for the nose portion (see FIG. 11A) having a length of L1 in the above described longitudinal direction is selected, employed and fixed in a state of being sandwiched between the two die blocks. In addition, the above described member 70 for the nose portion is structured so that the fixation thereof is released by loosening the bolt 47 from this fixation state, in a similar way to that in the above description. In this released state, the above described member 70 for the nose portion in a state of being sandwiched between the two die blocks can be removed from the side part of the die 2 (one or both outsides of the die 2 in the longitudinal direction of the base end portion 31).

In addition, in place of the above described removed member 70 for the nose portion, for instance, another member 70 for the nose portion having a length of L2 in the above described longitudinal direction is selected, is inserted between the two die blocks from the side part of the die 2, and is brought into contact with the nose portion 35a in the opening side of the remaining portion 35 of the extending portion 33 (see FIG. 11B). The member 70 for the nose portion can be mounted and fixed in the die by the tightening of the bolt 47 in this state, in a similar way to that in the above description. Thereby, the nose portion 34 is formed. Thus, the member 70 for the nose portion having a length of L1 in the above described longitudinal direction can be replaced with the member 70 for the nose portion having a length of L2 in the above described longitudinal direction. In addition, the coating width W can be decreased by such replacement (see FIG. 11B). Furthermore, the member 70 for the nose portion having the length of L2 in the above described longitudinal direction can also be replaced with the member 70 for the nose portion having the length of L1 in the above described longitudinal direction, in a similar way to that in the above description. Thereby, the coating width W can be increased (see FIG. 11A). Thus, the coating width W can be changed by the operation of replacing the member 70 for the nose portion with each other.

In addition, the coating width W in the longitudinal direction of the slot 10 can be changed by the operation of moving the replaced member for the first portion (here, the member 70 for the nose portion having the above described length of L1 or L2) relatively in the above described longitudinal direction, in a state of having been sandwiched between the two die blocks (see a dashed arrow in FIG. 11A or FIG. 11B).

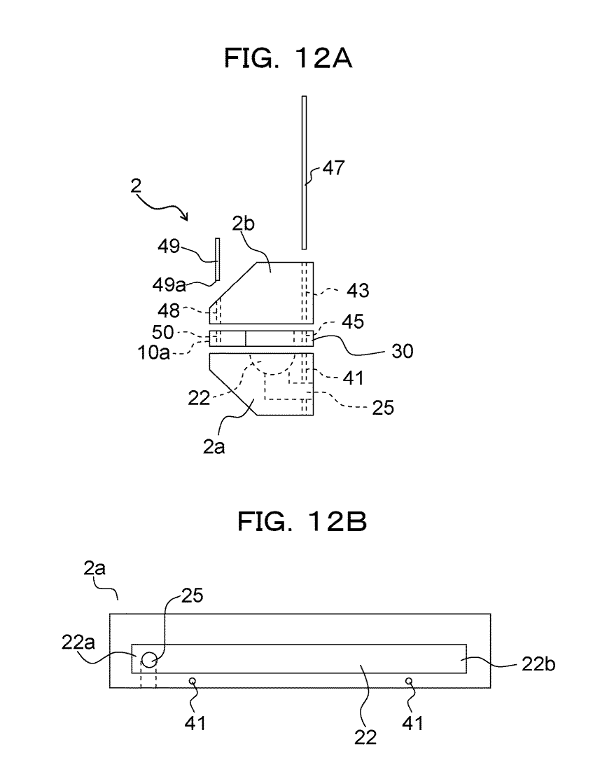

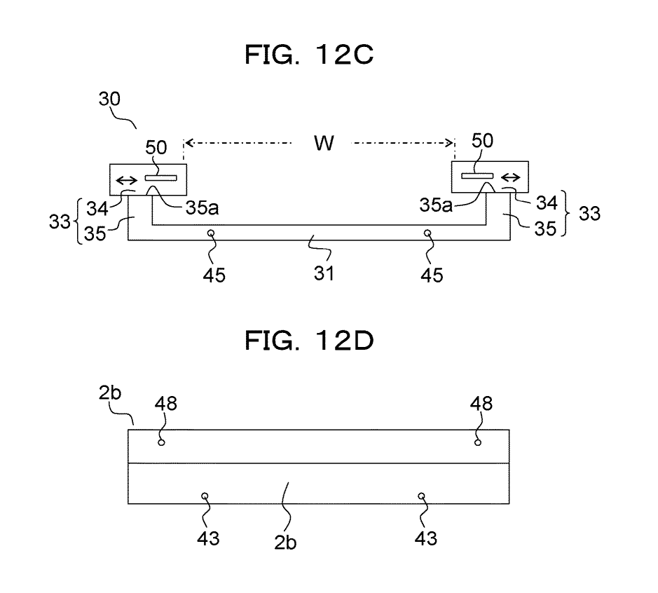

In the above description, such a structure has been shown that the shim member 30 is fixed and the fixation is released with the use of the bolt 47. However, in addition to the structure, such a structure can also be adopted that the shim member 30 is fixed and the fixation is released, for instance, with the use of a pressing bolt 49 (see FIG. 12 to FIG. 16).

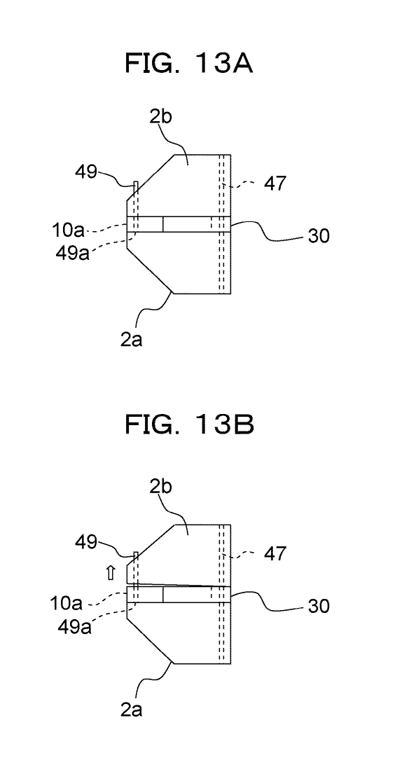

Specifically, such a structure shall be, for instance, a structure in which the base end portion 31 and the nose portion 34 are fixed by the above described bolt 47, as are illustrated in FIG. 12 and FIG. 13. The structure further shall be a structure in which the pressing bolt 49 is prepared that can adjust a space between the first die block 2a and the second die block 2b by pressing the first die block 2a from the second die block 2b side, and the fixation state and a fixation-released state of the nose portion 34 that is relatively movable are controlled by a pressing force of the pressing bolt 49.

Specifically, a threaded screw hole 48 through which the pressing bolt 49 is threaded is formed in the second die block 2b. In addition, a long through-hole 50 which the pressing bolt 49 penetrates is formed along the longitudinal direction in the nose portion 34, and the nose portion 34 can be moved in the above described longitudinal direction in such a state that the pressing bolt 49 penetrates the through-hole 50.

The pressing bolt 49 is screwed into the threaded screw hole 48 of the second die block 2b and thereby penetrates the through-hole 50 of the nose portion 34, and the tip 49a thereof abuts on the first die block 2a. In addition, when the pressing force of the pressing bolt 49 for the first die block 2a is small, the nose portion 34 is fixed by a connecting force of the bolt 47 in a state of being sandwiched between the two die blocks (see FIG. 13A).

When the pressing bolt 49 is screwed in this state, the tip 49a can press the first die block 2a, and the opening 10a side of the second die block 2b is pushed up to the upper side against the connecting force of the above described bolt 47, due to counteraction against this pressing force (see FIG. 13B). Thereby, a space between the first die block 2a and the second die block 2b in the opening 10a side increases, the fixation of the nose portion 34 is released, and the nose portion 34 can be moved relatively in the above described longitudinal direction. In addition, at this time, the base end portion 31 is fixed by the bolt 47, and accordingly the fixation only in the nose portion 34 can be released.

On the other hand, the pressing force of the first die block 2a in the tip 49a decreases by an operation of loosening the pressing bolt 49, and accordingly the nose portion 34 can be fixed by a connecting force of the bolt 47 in a state of being sandwiched between the two die blocks.

Thus, the shim member 30 is structured so that the shim member is fixed and the fixation is released by the pressing bolt 49, and thereby the fixation only in the first portion can be released simply by an operation of screwing or loosening the pressing bolt 49. Thereby, the coating width W can be more easily changed.

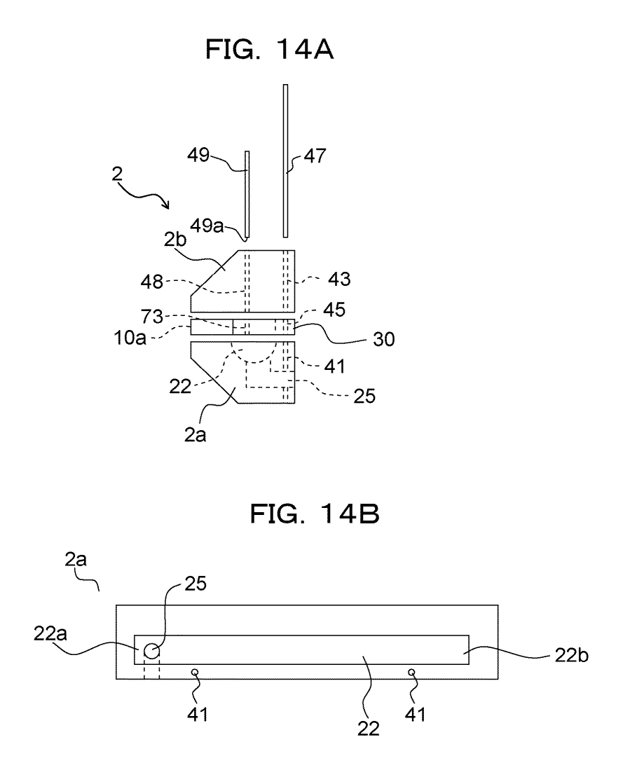

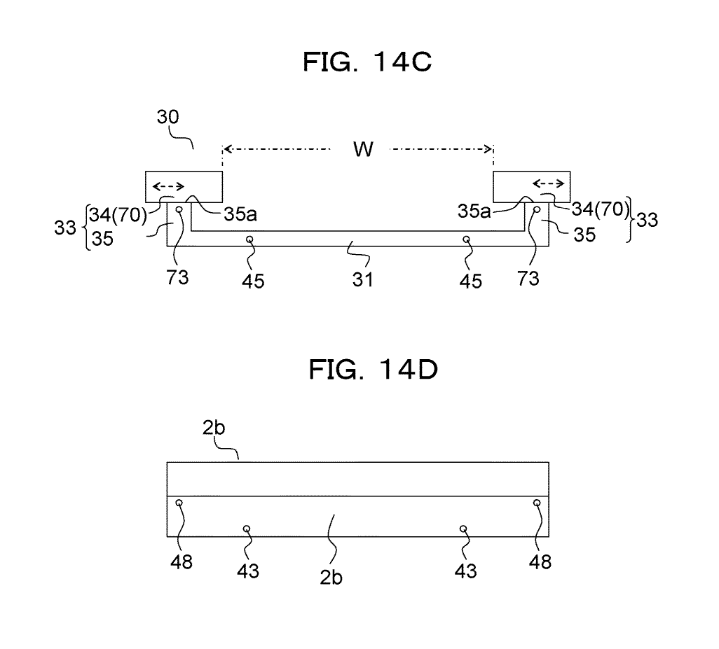

In addition to the above described structure illustrated in FIG. 12 and FIG. 13, other structures as are illustrated in FIG. 14 to FIG. 16, for instance, can also be adopted as a structure in which the shim member 30 is fixed and the fixation is released with the use of the pressing bolt 49.

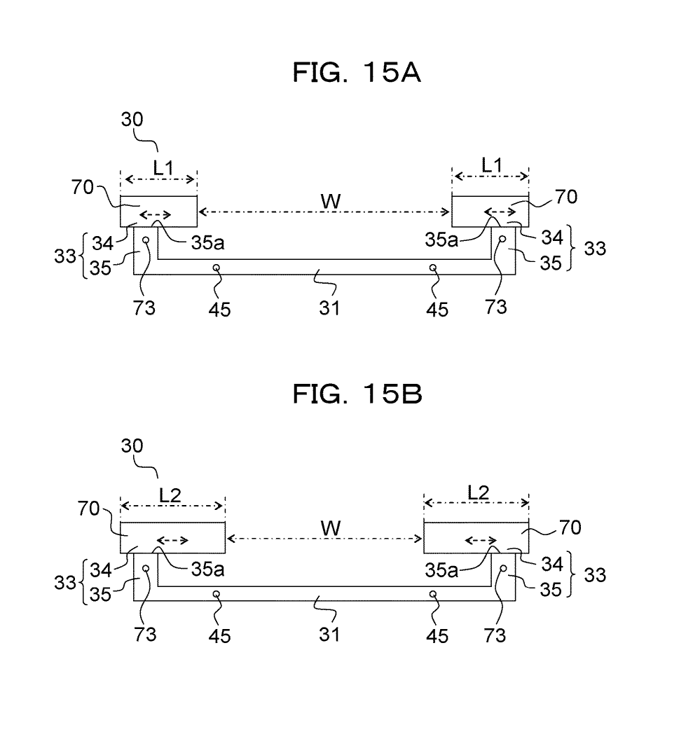

Specifically, as are illustrated in FIG. 14 and FIG. 15, the base end portion 31 and the nose portion 34 (or the member 70 for the nose portion) are structured so as to be fixed by the bolt 47. On the other hand, the through-hole 50 as described above is not formed in the nose portion 34 (or the member 70 for the nose portion). In addition, the shim member is structured so that the pressing bolt 49 is provided which can adjust a space between the first die block 2a and the second die block 2b by pressing the first die block 2a from the second die block 2b side, and the fixation state and the fixation-released state of the nose portion 34 (or the member 70 for the nose portion, which can be selected and employed) which is relatively movable are controlled by the pressing force of the pressing bolt 49, in a similar way to that in the above description. A through-hole 73 which the pressing bolt 49 penetrates is formed in the remaining portion 35 of the extending portion 33. The pressing bolt 49 penetrates the threaded screw hole 48 of the second the block 2b, and further penetrates the through-hole 73 of the remaining portion 35, and the tip 49a abuts on the first die block 2a.

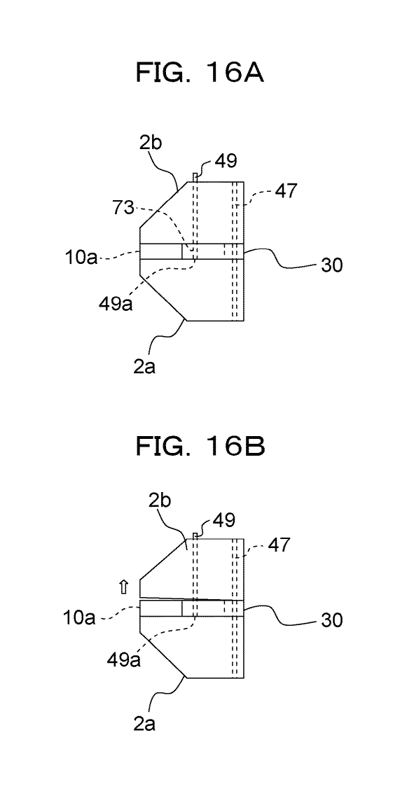

When the nose portion 34 is structured so as to be relatively movable as in the above description, for instance, the pressing bolt 49 is screwed in a state in which the nose portion 34 is fixed by being sandwiched between the two die blocks, as is illustrated in FIG. 16A. Thereby, the space between the first die block 2a and the second die block 2b increases in the opening 10a side and the fixation of the nose portion 34 is released in a similar way to that in the above description, as is illustrated in FIG. 16B. In addition, the shim member is structured so that the nose portion 34 can be relatively moved in this state (see a dashed arrow in FIG. 14C). On the other hand, the shim member is structured so that the nose portion 34 can be fixed in a state of being sandwiched between the two die blocks, in a similar way to that in the above description, by an operation of loosening the pressing bolt 49, as is illustrated in FIG. 16A.

In addition, when a plurality of members 70 for a nose portion are provided, and the first portion has a structure including one member 70 for the nose portion, which is selected from the plurality of the members and employed, as has been described above, the shim member 30 can be structured so that the shim member 30 is fixed and the fixation is released, as will be described below. Specifically, as is illustrated in FIG. 16A, for instance, the nose portion 34 has such a structure that the member 70 for the nose portion (see FIG. 15A) having a length of L1 in the above described longitudinal direction is selected, is employed and is fixed in a state of having been sandwiched between the two die blocks. The above described member 70 for the nose portion is structured so that the fixation thereof is released by an operation of screwing the pressing bolt 49 in this state, in a similar way to that in the above description, as is illustrated in FIG. 16B. In addition, in this state, the above described member 70 for the nose portion in a state of being sandwiched between the two die blocks can be removed from the side part of the die 2, as has been described above.

Furthermore, in place of the above described removed member 70 for the nose portion, for instance, another member 70 for the nose portion having a length of L2 in the above described longitudinal direction is selected, is inserted between the two die blocks from the side part of the die 2, as described above, and is brought into contact with the nose portion 35a in the opening side of the remaining portion 35 of the extending portion 33 (see FIG. 15B). In this state, the pressing bolt 49 is loosened. Thereby, the member 70 for the nose portion can be mounted and fixed in a similar way to that in the above description, as is illustrated in FIG. 16A. Thereby, the nose portion 34 is formed. Thus, the shim member is structured so that the member 70 for the nose portion having a length of L1 in the above described longitudinal direction can be replaced with the member 70 for the nose portion having a length of L2 in the above described longitudinal direction. In addition, the shim member is structured so that when the member 70 for the nose portion is replaced, the member 70 for the nose portion can be replaced by being taken out from and put into the space between the two die blocks, from the side part of the die 2, in a similar way to that in the above description. The shim member is further structured so that the member 70 for the nose portion having the length of L2 in the above described longitudinal direction can also be replaced with the member 70 for the nose portion having the length of L1 in the above described longitudinal direction, in a similar way to that in the above description.

In addition, the coating width W in the longitudinal direction of the slot 10 can be changed further by an operation of moving the replaced member for the first portion (here, the member 70 for the nose portion having the above described length of L1 or L2) relatively in the above described longitudinal direction, in a state of having been sandwiched between the two die blocks (see a dashed arrow in FIG. 15A or FIG. 15B).

Subsequently, a method for producing a coating film by using the above described die coater 1 will be described below.

The method for producing the coating film of the present embodiment is a method for producing the coating film, which produces the coating film 55 on the substrate 51, for instance, and includes: using the die coater 1 including the shim member 30 which is structured so that the first portion (here, the nose portion 34) can move in the longitudinal direction of the slot 10 relatively with respect to the second portion (here, the base end portion 31 and the remaining portion 35) (see FIG. 1); changing a coating width in the longitudinal direction of the slot 10 by moving the nose portion 34 in the longitudinal direction of the slot 10 relatively with respect to the base end portion 31 and the remaining portion 35; and producing the coating film 55 on the substrate 51 by making the slot 10 discharge the coating liquid 5 therefrom.

When the coating width W in the longitudinal direction of the slot 10 is decreased, for instance, the first portion (here, the nose portion 34) which is the nose portion 34 of at least one extending portion 33 or the whole of at least the one extending portion 33, out of the pair of the extending portions 33, is relatively moved toward the inside of the pair of the extending portions 33 in the above described longitudinal direction. When the coating width W in the longitudinal direction of the slot 10 is increased, the nose portion 34 is relatively moved toward the outside of the pair of the extending portions 33 in the above described longitudinal direction.

Specifically, when the coating width W in the longitudinal direction of the slot 10 is decreased, at least any one of the two nose portions 34 is relatively moved toward a side in which the pair of the extending portions 33 become close to each other, in other words, toward the inside (the arrow direction in FIG. 5A) of the pair of the extending portions 33 in the above described longitudinal direction, as is illustrated in FIG. 5A. On the other hand, when the coating width W in the longitudinal direction of the slot 10 is increased, at least any one of the two nose portions 34 is relatively moved toward a side in which the pair of the extending portions 33 become distant from each other, in other words, toward the outside (an arrow direction in FIG. 5B) of the pair of the extending portions 33 in the above described longitudinal direction, as is illustrated in FIG. 5B.

In addition, the method for producing the coating film of the present embodiment is a method for producing the coating film, which produces the coating film 55 on the substrate 51, for instance, includes: using the die coater 1 including the shim member 30 which is structured so that a plurality of members (here, the member 70 for the nose portion) for the first portion (here, the nose portion 34) are provided, respectively, the plurality of the members 70 for the nose portion have lengths different from each other in the above described longitudinal direction when used as the nose portion 34, the nose portion 34 has a structure including one member 70 for the nose portion, which is selected from the plurality of the members 70 for the nose portion and employed, and members to be used are structured so as to be replaceable with each other (see FIG. 1); changing the coating width W in the longitudinal direction of the slot 10 by replacing a member 70 for the nose portion, which is selected from the above described plurality of the members 70 for the nose portion and employed, with another member 70 for the nose portion; and producing the coating film 55 on the substrate 51 by making the slot 10 discharge the coating liquid 5 therefrom.

When the coating width W in the longitudinal direction of the slot 10 is decreased, for instance, one member (here, a member 70 for the nose portion having the above described length of L1) which is selected from a plurality of members (here, the member 70 for the nose portion having the above described length of L1 and the member 70 for the nose portion having the above described length of L2) for the first portion (here, the nose portion 34) which is the nose portion 34 of at least one extending portion 33 or the whole of at least the one extending portion 33, out of the pair of the extending portions 33, and employed, is replaced with another member (here, the member 70 for the nose portion having the above described length of L2) which has a length in the above described longitudinal direction larger than that of the one member. On the other hand, when the coating width W in the longitudinal direction of the slot 10 is increased, for instance, one member (here, the member 70 for the nose portion having the above described length of L2) which is selected from a plurality of members and employed is replaced with another member (here, the member 70 for the nose portion having the above described length of L1) which has a length in the above described longitudinal direction smaller than that of the one member. In addition, as has been described above, when the member 70 for the nose portion is replaced, the member 70 for the nose portion can be replaced by being taken out from and put into the space between the two die blocks, from the side part of the die 2.

Specifically, when the coating width W in the longitudinal direction of the slot 10 is decreased, a plurality of members 70 for the nose portion are provided for at least any one of the two nose portions 34 (here, the member 70 for the nose portion having the above described length of L1 and the member 70 for the nose portion having the above described length of L2), one member 70 for the nose portion (here, the member 70 for the nose portion having the above described length of L1) which is selected from the plurality of the members 70 for the nose portion and employed, as is illustrated in FIG. 11A or FIG. 15A, is replaced with another member 70 for the nose portion (here, the member 70 for the nose portion having the above described length of L2) which has a length in the above described longitudinal direction larger than that of the one member. On the other hand, when the coating width W in the longitudinal direction of the slot 10 is increased, for instance, one or a pair of members 70 for the nose portion (here, the member 70 for the nose portion having the above described length of L2) which is selected from the above described plurality of the members 70 for the nose portion and employed, as is illustrated in FIG. 11B or FIG. 15B, is replaced with another member 70 for the nose portion (here, the member 70 for the nose portion having the above described length of L1) which has a length in the above described longitudinal direction smaller than that of the one or the pair of the members, as is illustrated in FIG. 11A or FIG. 15A.

In addition, in such a production method, the coating width W in the longitudinal direction of the slot 10 can be changed further by an operation of moving the replaced member for the first portion (here, the member 70 for the nose portion having the above described length of L1 or L2) relatively in the above described longitudinal direction (see dashed arrows in FIG. 11A, FIG. 11B, FIG. 15A and FIG. 15B).

As has been described above, the shim member 30 of the present embodiment is a shim member 30 which is sandwiched between two die blocks that the die 2 has and are arranged so as to face each other and is formed in such a U shape as to be opened toward the slot 10 side so that the slot 10 which is the discharge port of the coating liquid 5 is formed at the nose portion of the die 2 provided in the die coater 1, wherein the U shape is formed by the base end portion 31 which is arranged so as to extend in the longitudinal direction of the slot 10, and a pair of extending portions 33 which extend toward the nose portion of the die 2 from both ends in the longitudinal direction of the base end portion 31; and the first portion (the nose portion 34) which is the nose portion 34 of at least one extending portion 33 or the whole of at least the one extending portion 33, out of the pair of the extending portions 33, and the second portion (the base end portion 31 and the remaining portion 35) which includes at least the base end portion 31, are structured so as to be separable from each other. Specifically, the above described first portion and the above described second portion are structured so as to be separable from each other along the longitudinal direction of the base end portion 31.

In such a structure, the first portion which is the nose portion 34 of at least one extending portion 33 or the whole of at least the one extending portion 33, out of the pair of the extending portions 33, and the second portion which is the remaining portion including the base end portion 31, are structured so as to be separable from each other. Thereby, the first portion can be structured, for instance, so as to be movable in the longitudinal direction relatively with respect to the second portion. In this case, the coating width W can be changed by an operation of relatively moving the first portion in a state in which the first portion is sandwiched between the two die blocks.

In addition, the shim member can also be structured so as to form the first portion by preparing a plurality of members for the first portion, which have different lengths from each other in the above described longitudinal direction when used as the first portion, respectively, and by replacing the member for the first portion with another member. In this case, the coating width W can be changed by the operation of replacing the member for the first portion.

Accordingly, the coating width W can be changed to a desired width without the operation of disassembling the die coater 1. Accordingly, the coating width W can be easily changed.

In addition, as has been described above, when the first portion is formed by the operation of replacing the above described member for the first portion, the above described member for the first portion can be inserted into the space between the two die blocks from the side part of the die 2, and the above described member for the first portion, which is arranged between the two die blocks, can be taken out from the side part of the die 2. Specifically, the above described member for the first portion can be taken out from and put in the space between the two die blocks from the side part of the die 2.

Here, the nose portion in the opening 10a side of the die 2 exerts the largest influence on the application (the discharge of the coating liquid 5 from the slot 10) of the coating liquid 5 onto the substrate 51, and accordingly the nose portion is required so as to have the highest machining accuracy out of portions in the die 2. However, when the above described member for the first portion is taken out from and put in the space between the two die blocks, from the front part (from slot 10 side) of the die 2, the above described nose portion may be damaged. When such a damage has occurred, it becomes difficult for the coating film 55 to be formed uniformly in the width direction of the slot 10.

In regard to this point, as has been described above, the member for the first portion can be taken out from and put in the space between the two die blocks from the side part of the die 2, which can avoid the damage from being caused in the nose portion as in the above description.

In addition, in the present embodiment, the above described first portion is preferably structured so as to be movable in the longitudinal direction of the slot 10 relatively with respect to the above described second portion.

The shim member 30 having such a structure can change the coating width W to a desired width only by moving the above described first portion in the longitudinal direction of the slot 10 relatively with respect to the above described second portion, in a state of being sandwiched between the two die blocks, without being removed from the die blocks. Accordingly, the coating width W can be more easily changed.

In addition, in the present embodiment, it is preferable that the above described first portion is a nose portion of at least one of the pair of the above described extending portions, and the nose portion extends along the above described longitudinal direction so as to project at least toward the inside. The first portion is preferably the nose portion 34 of at least one of the pair of the extending portions 33.

The shim member having such a structure can be structured, for instance, so that the nose portion 34 can relatively move. In this case, the shim member can change the coating width only by relatively moving the nose portion 34. In addition, the shim member can also be structured so as to form the nose portion 34 by providing a plurality of members for the nose portion (the member 70 for the nose portion), selecting one member 70 for the nose portion from these members and employing the member. In this case, the shim member can change the coating width only by replacing the member 70 for the nose portion with another member.

Accordingly, the coating width W is more easily changed.

In addition, in the present embodiment, it is preferable that at least one extending portion of the pair of the extending portions 33 has the nose portion 34 which extends so as to project toward the inside and the outside along the above described longitudinal direction and is formed so as to be a T-shape, and the first portion is the nose portion 34. Specifically, it is preferable that the above described first portion is a nose portion of at least one extending portion out of the pair of the above described extending portions, and the nose portion extends along the above described longitudinal direction so as to project toward the inside and the outside. Thus, a part of the nose portion 34 projects to the outer side than the space between the die blocks, and thereby this projecting portion can be grasped by fingers. Thereby, when the nose portion 34 is structured so as to be relatively movable, as has been described above, for instance, the nose portion 34 is facilitated to be relatively moved. In addition, for instance, when a plurality of members 70 for the nose portion are provided, and the nose portion 34 has a structure including one member 70 for the nose portion, which is selected from the plurality of the members and employed, as has been described above, the member 70 for the nose portion becomes easy to be replaced.

In addition, both of the nose portions 34 are preferably determined to be the above described first portion, and the shim member having such a structure can facilitate the center in the longitudinal direction of the die 2 to be easily aligned with the center of the coating width W. As a result, the coating liquid 5 can be easily applied onto the center of the substrate 51 without a complicated adjustment operation.

In addition, in the present embodiment, it is preferable that the plurality of the above described members for the first portion are provided, respectively, the plurality of the members have lengths different from each other in the above described longitudinal direction when used as the above described first portion, the above described first portion has a structure including one member which is selected from the plurality of the members and employed, and members to be used are structured so as to be replaceable with each other.

The shim member having such a structure can change the coating width W only by replacing the above described member with another member and forming the first portion, and accordingly can more easily change the coating width W. In addition, the coating width W can also be comparatively largely changed.

In addition, the above described member can be taken out from and put in the space between the two die blocks from the side part of the die 2, which can accordingly avoid the damage as describe above from being caused in the nose portion in the opening 10a side of the die 2.

Here, when a part of the first portion (here, the nose portion 34) projects to the outer side than the space between the die blocks, as has been described above, for instance, the nose portion 34 can be structured so that this projecting portion is relatively moved while being grasped by fingers.

However, when such a structure has been adopted, if the nose portion 34 has been excessively moved to the outer side so that the coating width W becomes large, the above described projecting portion excessively projects to the outer side and may accidentally collide with a device arranged in the periphery of the portion, an operator or the like. In addition, if the nose portion 34 has been excessively moved to the inner side so that the coating width W becomes small, the above described projecting portion is excessively recessed toward the inner side and may not be grasped by fingers.

Thus, when the first portion has been structured so as to be relatively movable, the extent to which the coating width is changed cannot be increased, and the extent to which the coating width W is changed may be limited.

On the other hand, when the shim member is structured so as to provide a plurality of members for the first portion (here, the member 70 for the nose portion) and form the first portion (here, the nose portion 34) is structured by selecting one member from these members and employing the member, as has been described above, the extent to which the coating width W is changed can be comparatively increased. Thereby, when the member for the first portion has been replaced with another member and the another member has formed the first portion, the coating width W can be changed to a desired width, while the degree of the projection in the above described projecting portion is controlled to an appropriate value.

In addition, it becomes easy to take the above described member out from and put the above described member in the space between the two die blocks, from the side part of the die 2.

In addition, it is preferable that the shim member is structured further so as to be capable of moving the above described replaced member relatively in the above described longitudinal direction, in addition to being structured so as to provide a plurality of members for the first portion and form the first portion by selecting one member from these members and employing the selected member, as has been described above.

Thereby, the above described replaced member can be further moved relatively in the above described longitudinal direction, and accordingly the coating width W can be changed more minutely. For instance, the coating width W can be changed in such a method as to change the coating width W in a comparatively large degree by replacing the above described member with another member, and changing the coating width W in a comparatively small degree by moving the above described replaced member (the first portion) relatively with respect to the second portion.

Incidentally, in the above described present embodiment, a structure has been illustrated in which the first portion is the nose portion 34 of both of the extending portions 33 out of the pair of the extending portions 33, but the first portion is not limited in particular as long as the first portion is the nose portion 34 of at least one extending portion 33 or the whole of at least the one extending portion 33, out of the pair of the extending portions 33.

Next, a die coater provided with the shim member according to a second embodiment of the present invention will be described below. Incidentally, portions which are common to those of the first embodiment will be designated by the common reference numerals, and the description will not be repeated.

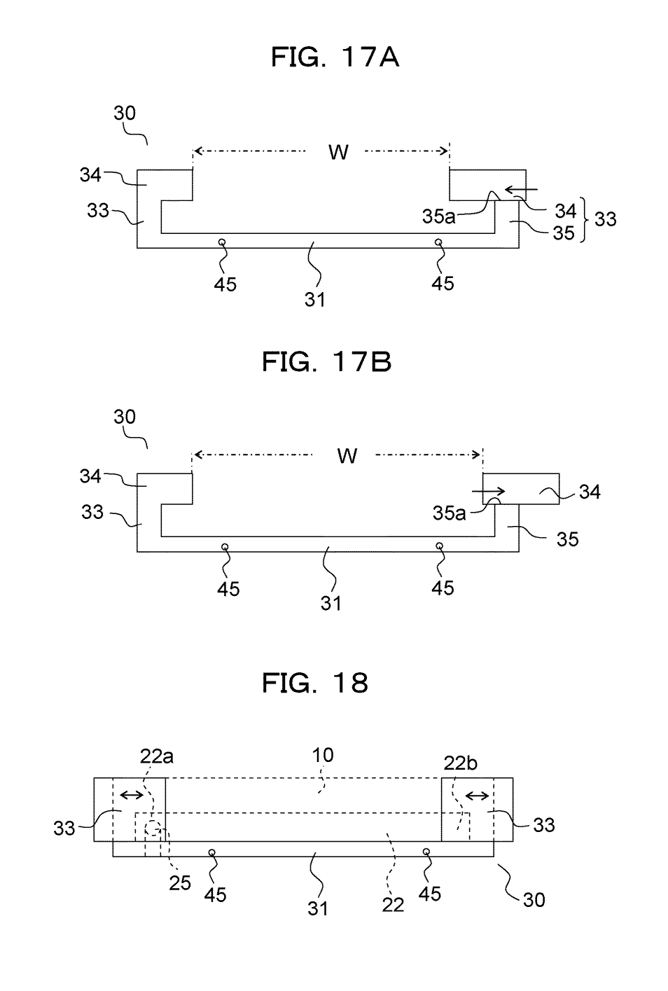

As is illustrated in FIG. 17, in the present embodiment, a pair of extending portions 33 are formed so as to have nose portions 34 which extend so as to project at least toward the inside along the above described longitudinal direction, and the nose portion 34 of one of the pair of the extending portions 33 is determined to be the above described first portion. More specifically, one extending portion 33 (an extending portion 33 in the right side in FIG. 17) of the pair of the extending portions 33 has the nose portion 34 which extends so as to project inside and outside, and is formed so as to be a T-shape. On the other hand, the other extending portion 33 (an extending portion 33 in the left side in FIG. 17) has a nose portion 34 which extends so as to project inside, and is formed so as to be an L-shape. The nose portion 34 of the extending portion 33 in the above described right side of the pair of the extending portions 33 is determined to be the above described first portion.

Specifically, the shim member 30 is structured so as to be separable into the two portions of the above described first portion and the above described second portion, in the one extending portion 33, along the longitudinal direction of the base end portion 31; and is structured so that the above described first portion is the nose portion 34 which is a separate portion, and the above described second portion is an indivisible integrated portion formed of the base end portion 31, a remaining portion 35 of the extending portion 33 in a side in which the nose portion 34 can be separated, and the extending portion 33 in a side in which the nose portion 34 cannot be separated. In addition, such an indivisible integrated portion is structured so as to be connected together with the first die block 2a and the second die block 2b by a bolt 47 and be fixed in a similar way to that in the above description, and thereby the shim member 30 is structured so as to be fixed. On the other hand, the shim member 30 is structured so that the fixation thereof is released by an operation of loosening the bolt 47.

The coating width W can be controlled so as to become comparatively small as is illustrated in FIG. 17A, for instance, by an operation of moving the nose portion 34 which is the above described separate portion, toward the inside (the arrow direction in FIG. 17A) of the pair of the extending portions 33 in the above described longitudinal direction. On the other hand, the coating width W can be controlled so as to become comparatively large as is illustrated in FIG. 17B, by an operation of moving the nose portion 34 toward the outside (the arrow direction in FIG. 17B) of the pair of the extending portions 33 in the above described longitudinal direction.

In the present embodiment as well, it is also possible to provide a plurality of members for the first portion and form the first portion by selecting one member from these members and employing the member, and to fix the first portion and release the fixation thereof by using the pressing bolt 49, in a similar way to those in the above described first embodiment. Other structures including these structures are similar to those in the first embodiment, and accordingly the description will not be repeated.

In the present embodiment, the shim member 30 is structured in this way, and thereby the shim member 30 can have such a structure, for instance, that one of the first portions (here, the nose portion 34) is relatively movable, or as to provide a plurality of members (here, the member 70 for the nose portion) for the first portion and form one of the first portions (here, the nose portion 34) by selecting one member from these members and employing the member. Thereby, the shim member 30 is easily produced, and the coating width is more easily changed.

Next, a die coater provided with a shim member according to a third embodiment of the present invention will be described below. Incidentally, portions which are common to those of the above described first embodiment are designated by the common reference numerals, and the description will not be repeated.

As is illustrated in FIG. 18, in the present embodiment, the shim member 30 is structured so that the first portion is the whole of at least one of a pair of the extending portions 33. More specifically, in the present embodiment, the first portion is structured so as to be the whole of both of the pair of the extending portions 33. For instance, the shim member 30 has a pair of rectangular extending portions 33, and the above described first portion which is the whole of both of the extending portions 33 and the second portion which is the base end portion 31 are structured so as to be separable from each other in the longitudinal direction of the base end portion 31. In addition, the extending portion 33 is arranged so that a part of the extending portion 33 projects to the outer side than the space between the die blocks, and thereby is structured so that this projecting portion can be grasped by fingers.

In the present embodiment as well, it is also possible to provide a plurality of members for the first portion and form the first portion by selecting one member from these members and employing the member, to fix the first portion and release the fixation thereof by using a bolt 47, and to fix the first portion and release the fixation thereof by using a pressing bolt 49, in a similar way to those in the above described first embodiment. Other structures including these structures are similar to those in the first embodiment, and accordingly the description will not be repeated.

In the present embodiment, the first portion is structured so as to be the whole of at least one of the pair of the extending portions 33, and thereby the shapes of the first portion and the second portion can be further simplified. Furthermore, the extending portion 33 has a rectangular shape, and thereby the shim member 30 is more easily formed.

In addition, the present invention is not limited to the above described embodiments, but can be modified in various ways in such a range as not to deviate from the scope of the present invention. For instance, as for such a structure that the shim member 30 is fixed in a state of being sandwiched between the first die block 2a and the second die block 2b and the fixation is released in the state, the other structures than the structure as described above can also be adopted, in which the shim member 30 is fixed with the use of the bolt 47 and the pressing bolt 49 and the fixation thereof is released therewith. In addition, as has been described above, such a structure can be adopted that the first portion (for instance, the nose portion 34 or the extending portion 33) has the portion which projects to the outer side than the space between the die blocks, but when such a structure has been adopted, the shape of this projecting portion is not limited in particular. In addition, it is also possible to form the first portion so that such a projecting portion does not exist, and also possible to arrange the first portion between the two die blocks.

### EXAMPLES

### Reference Example 1

As is illustrated in FIG. 4C, a die coater 1 was used which was provided with a shim member having a nose portion 34 with a rectangular shape and was illustrated in FIG. 1.

A liquid in which an acrylic tackiness agent was dissolved in a mixture of toluene and ethyl acetate was used as the coating liquid. A polyethylene terephthalate (PET) film (MRF38, 38 μm in thickness and 1,300 mm in width, made by Mitsubishi Plastics, Inc.) was used as a substrate.

The transportation speed of the substrate in the longitudinal direction was set at 28 m/min, and the coating width W thereof was set at 1,280 mm. The coating liquid was applied onto the substrate with the use of the above described die coater 1, and then was dried. Thereby, a coating film was formed on the substrate. The thickness of the formed coating film was measured throughout the width direction with the use of an optical interference type of thickness indicator (MCPD series, made by Otsuka Electronics Co., Ltd.). The obtained result is illustrated in FIG. 20. Incidentally, similar results were obtained in both end sides in the width direction of the coating film. Accordingly, FIG. 20 illustrates a result in one end side in the width direction of the coating film. In addition, in FIG. 20, an X-axis represents a distance from one end edge. In addition, an amount of chamfer in the nose portion used in Reference Example 1, which will be described later, corresponds to 0 mm.

### Reference Example 2

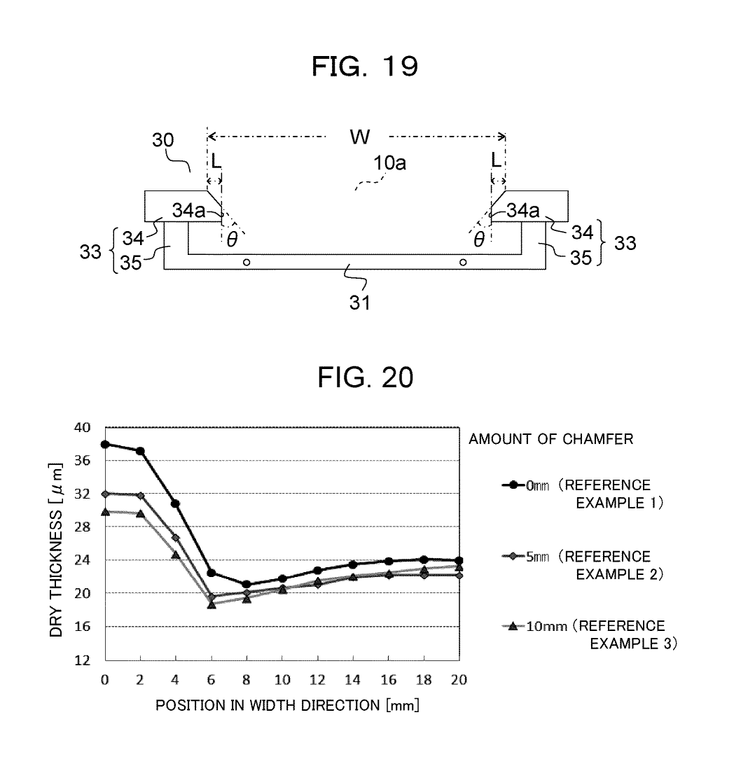

As illustrated in FIG. 6C and FIG. 19, a nose portion 34 was used which was formed so that an opening 10a side in the inside of the nose portion 34 (the upper side in each figure) was chamfered, in other words, so that the distance from each other expanded toward the opening 10a side. In addition, as illustrated in FIG. 19, an inclining angle θ of the chamfered portion with respect to the end edge 34a (the vertical direction in FIG. 19) of the inside of the nose portion 34 was set at 30°, a length of the chamfered portion from the end edge 34a of the inside in the width direction of the nose portion 34 (the amount of chamfer, in other words, an amount of an expanded distance in the end edge in the opening 10a side of the one nose portion 34, between the end edge and an end edge in the opening 10a side of the other nose portion 34) L was set at 5 mm, and the coating width (a distance between the end edges in the opening 10a side in the nose portions 34) W was set at 1,280 mm.

The coating liquid was applied onto the substrate, and the thickness of the coating film formed on the substrate was measured throughout the width direction, in a similar way to that in Reference Example 1, except that the nose portion 34 formed with the above method was used. The obtained result is illustrated in FIG. 20.

### Reference Example 3

The coating liquid was applied onto the substrate, and the thickness of the coating film which was formed on the substrate was measured throughout the width direction in a similar way to that in Reference Example 2, except that the length L (the amount of the chamfer) of the chamfered portion from the end edge 34a of the inside in the width direction was set at 10 mm. The obtained result is illustrated in FIG. 20.

As is illustrated in FIG. 20, in the case where the chamfered portion is provided (5 mm and 10 mm), humps or rounded protrusions in both ends in the width direction of the coating film can be more suppressed than those in the case where the chamfered portion is not provided (0 mm). Thereby, it was found that the shim member could more surely uniformize the thickness of the coating film throughout the width direction.

In addition, in the present reference example, in the case where the amount of the chamfer was 10 mm, the above described humps or rounded protrusions in both ends could be more suppressed than those in the case where the amount of the chamfer was 5 mm, but on the other hand, there was a tendency that portions of which the coating films were thinner than the coating film in the central side appeared in both ends, as compared to the case where the amount of the chamfer was 5 mm.

According to the above description, the humps or rounded protrusions in both ends in the width direction of the coating film can be suppressed by the chamfered portion provided on the nose portion. Thereby, it was found that the shim member could more surely uniformize the thickness of the coating film throughout the width direction. Furthermore, the decrease of the thickness in both of the ends can be suppressed by an operation of adjusting the amount of the chamfer so as not to become excessively large. Thereby, it was found that the shim member could further surely uniformize the thickness of the coating film throughout the width direction.

What is claimed is:

1. A shim member which is sandwiched between two die blocks that a die has and are arranged so as to face each other and is formed in such a U shape as to be opened toward a slot side so that the slot which is a discharge port of a coating liquid is formed at a nose portion of the provided in a die coater, wherein
the U shape is formed by a base end portion which is arranged so as to extend in a longitudinal direction of the slot, and a pair of extending portions which extend toward the nose portion of the die from both ends in a longitudinal direction of the base end portion; and
a first portion which is a nose portion of at least one extending portion or the whole of at least the one extending portion, out of the pair of the extending portions, and a second portion which is a remaining portion including at least the base end portion, are structured so as to be separable from each other.

2. The shim member according to claim 1, wherein the first portion is structured so as to be movable in the longitudinal direction of the slot relatively with respect to the second portion.

3. The shim member according to claim 1, wherein the first portion is a nose portion of at least one of the pair of the extending portions, and
the nose portion extends along the longitudinal direction so as to project at least toward the inside.

4. The shim member according to claim 3, wherein the nose portion is structured so as to form such a shape that the distance from each other expands toward an opening side of the slot.

5. The shim member according to claim 1, wherein the first portion is the whole of at least one of the pair of the extending portions.

6. The shim member according to claim 1, wherein
a plurality of members for the first portion are provided, respectively,
the plurality of the members have lengths different from each other in the longitudinal direction when used as the first portion,
the first portion has a structure including one member which is selected from the plurality of the members and employed, and
members to be used are structured so as to be replaceable with each other.

7. A die coater comprising the shim member according to claim 1.

8. A method for producing a coating film, which produces the coating film on a substrate, comprising:
using a die coater including the shim member according to claim 2;
changing a coating width in a longitudinal direction of the slot by moving the first portion in the longitudinal direction of the slot relatively with respect to the second portion; and
producing the coating film on the substrate by making the slot discharge the coating liquid therefrom.

9. A method for producing a coating film, which produces the coating film on a substrate, comprising:
using a die coater including the shim member according to claim 6;
changing a coating width in the longitudinal direction of the slot by replacing a member which is selected from the plurality of the members and employed, with another member; and
producing the coating film on the substrate by making the slot discharge the coating liquid therefrom.

10. The method for producing the coating film according to claim 9, further comprising changing the coating width in the longitudinal direction of the slot further by moving the replaced member relatively in the longitudinal direction.
